(19) United States
(12) Patent Application Publication
(10) Pub. No.: US 2007/0045159 A1
(43) Pub. Date: Mar. 1, 2007

(54) Water purifying system with removable storage tank

(76) Inventor: Shih-Ping Lee, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/504,012

(22) Filed: Aug. 15, 2006

(30) Foreign Application Priority Data
Aug. 23, 2005 (TW) 094214427

(51) Int. Cl. B01D 35/14

(52) U.S. Cl. 210/86; 210/192; 210/257.1; 210/258; 210/449

(57) ABSTRACT

A water purifying system includes a base having a storage tank removably connected thereto and purifying device is connected to the storage tank so as to provide purified water into the storage tank. A pumping device pumps the purified water in the storage tank to a faucet. A high level detection unit is located in the storage tank and a low level device is connected to a pipe connected between the storage tank and the pump. The high level detection unit controls the pump to pump the purified water into the storage tank, and the low level detection unit stop the operation of the pump when no water is left in the storage tank so as to protect the pump.

### FIELD OF THE INVENTION

The present invention relates to a water purifying system with a removable water tank and a level detection device for checking the level of the water in the storage tank so as to properly activate the pump system.

### BACKGROUND OF THE INVENTION

A conventional water purifying system is shown in FIGS. 8 and 9, and generally includes a purifying unit 91 which can be any type of known purifying device such as reverse osmosis system and unpurified water is introduced into each of the reverse osmosis tubes of the purifying unit 91 to isolate and remove the particles in the water and the purified water are then collected into a storage tank 92. A pipe is then connected to a faucet 9 from which the purified water can be obtained. The storage tank 92 includes a flexible separation film 921 to define an upper space 922 and a lower space 923. Pressurized air is introduced into the lower space 923 so that when the user operates the valve on the faucet 93, the separation film 921 is deformed and pushes the water in the upper space to force the water in the upper space 922 to flow out from the faucet 93. Nevertheless, the conventional water purifying system occupies a lot of space and a longer pipe system is needed which may increase the possibility of contamination of the water.

The present invention intends to provide a water purifying system wherein the storage tank is conveniently installed to or removed from the base of the system. A level detection device is used to check the level of the water in the storage tank to prevent the pump system from being damaged when no water in the storage tank.

### SUMMARY OF THE INVENTION

The present invention relates to a water purifying system that comprises a base having a storage tank removably connected thereto and an outlet is defined through a wall of the base and communicates with an interior of the storage tank. A one-way valve is engaged with the outlet. A control device is connected to the base. A pump for pumping water in the storage tank out from the outlet is received in the base 11 and a first pipe is connected between the one-way valve and the pump. A second pipe is connected between the second hole and the pump. The pump is controlled by the control device. A level detection device has a high level detection unit and a low level detection unit, wherein the high level detection unit is connected between a second pipe and the storage tank, and the low level detection unit is connected to the first pipe. A purifying device is received in the base and a third pipe is connected between the first hole and the purifying device. A faucet has a switch which is electrically connected with the control device, and a third pipe is connected between the faucet and the second hole.

The primary object of the present invention is to provide a water purifying system which has a compact base combined with a removable storage tank, and the storage tank is cooperated with a one-way valve to prevent water from re-entrance into the storage tank.

Another embodiment of the present invention is to provide a water purifying system which has a high level detection device and a low level detection device so as to accurately detect the level of the water level in the storage tank and protect the pump which is stopped when the storage tank has no water left.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows the water purifying system of the present invention;

FIG. 2 is a side cross sectional view of the water purifying system of the present invention;

FIG. 3 shows the operation steps of the water purifying system of the present invention;

FIG. 4 is an exploded view to show the storage tank and the base of the water purifying system of the present invention;

FIG. 5 shows that the water purifying system of the present invention is located beneath the counter top of kitchen sink;

FIG. 6 shows that a ultra-violet sterilizer unit is connected to the water purifying system of the present invention;

FIG. 7 shows that a water quality detection device is connected to the base of the water purifying system of the present invention;

FIG. 8 shows a conventional water purifying system, and

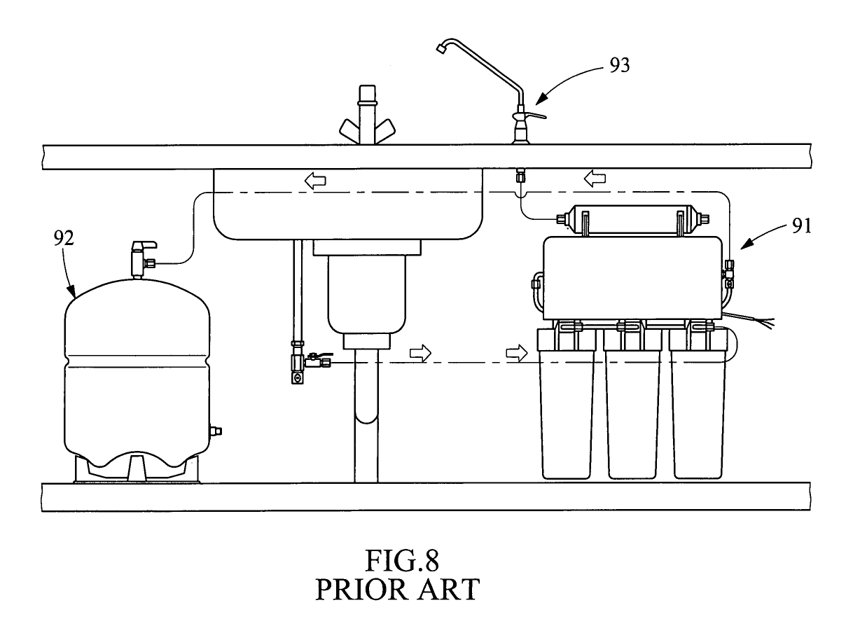

FIG. 9 shows the storage tank of the conventional water purifying system in FIG. 8.

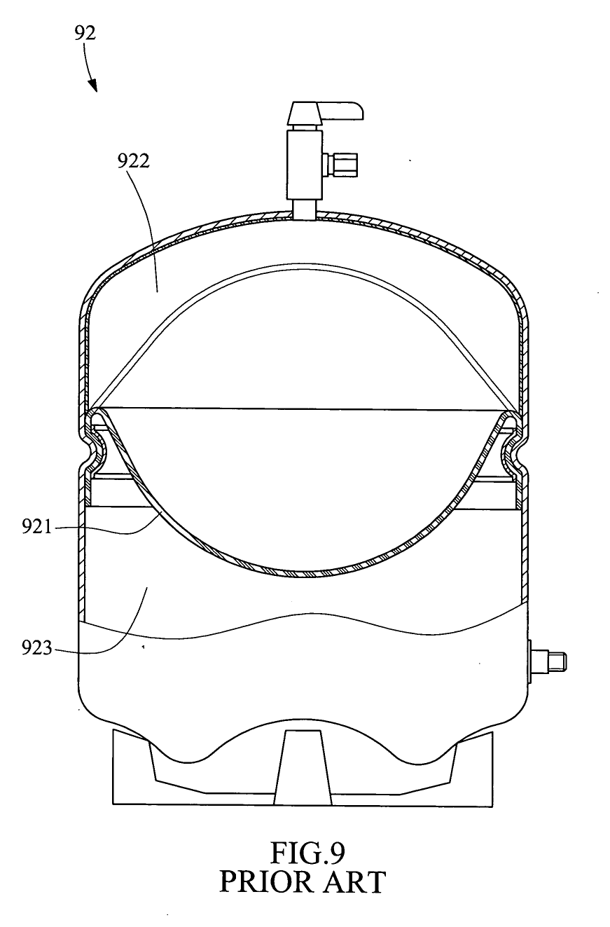

### DETAILED DESCRIPTION OF THE PREFERRED EMBODIMENT

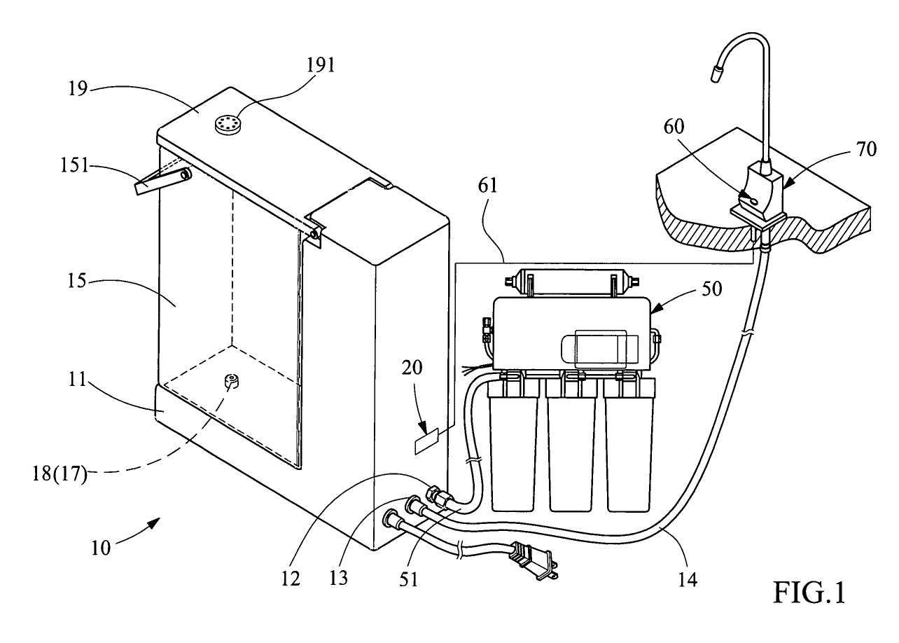

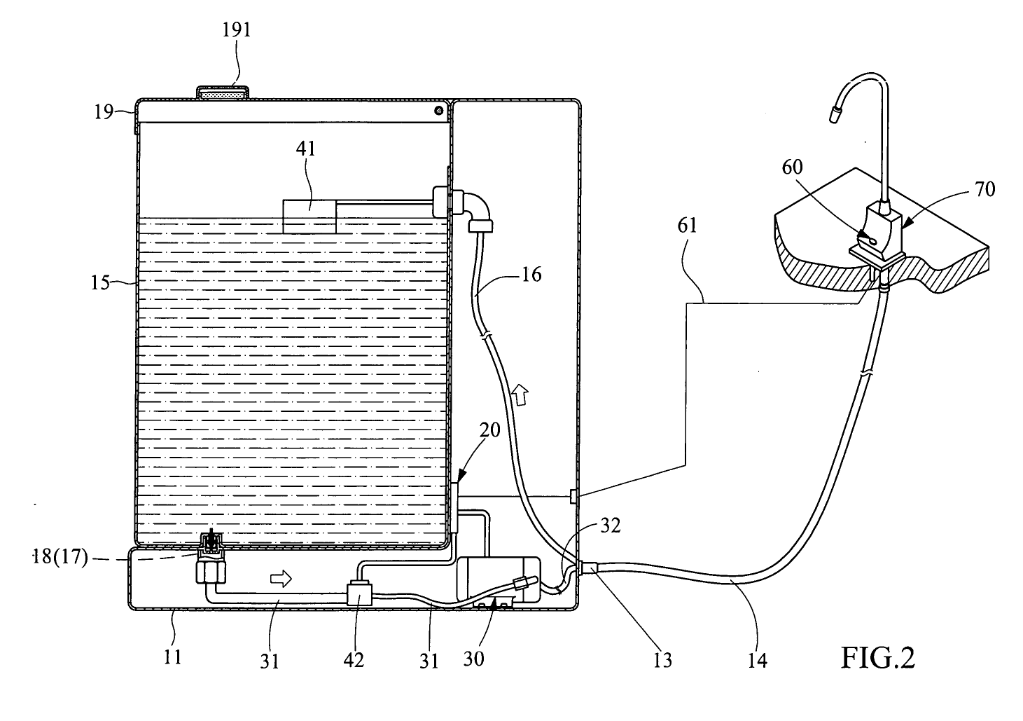

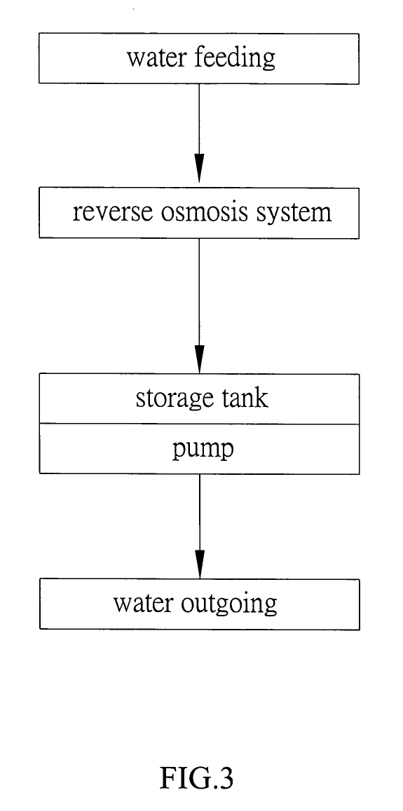

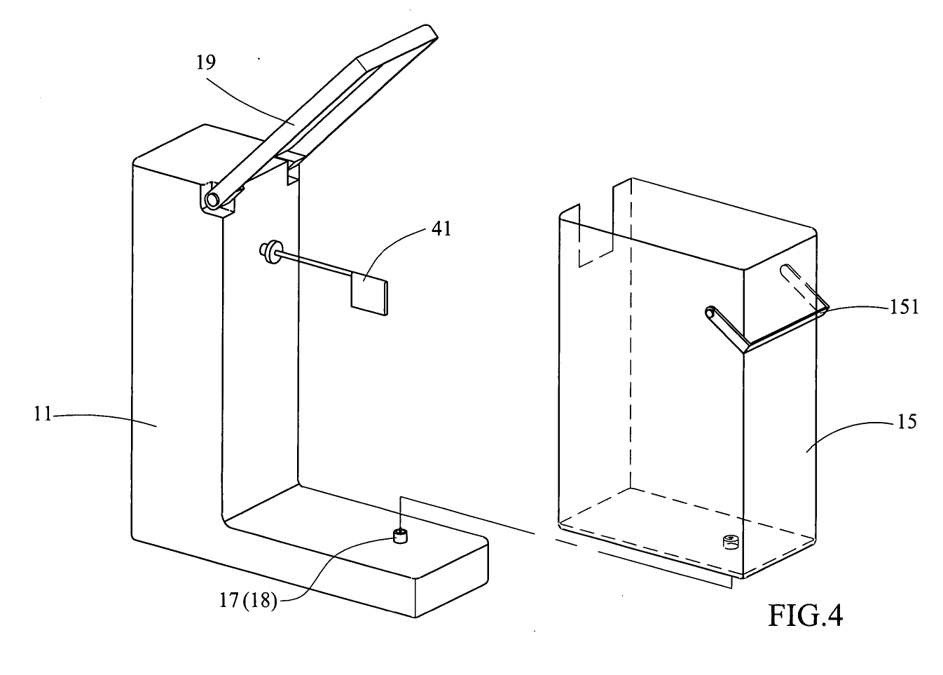

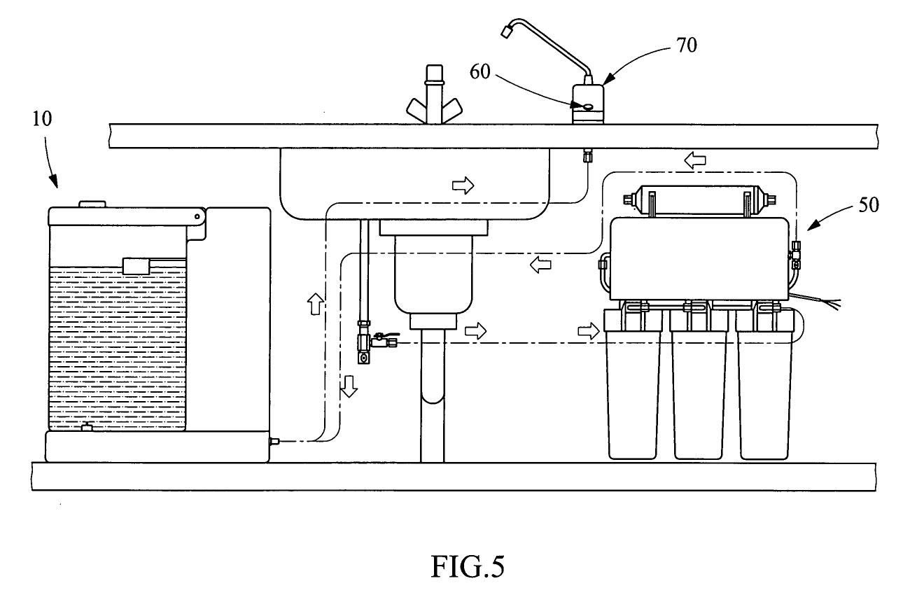

Referring to FIGS. 1 to 5, the water purifying system 10 of the present invention comprises a base 11 having a first hole 12 and a second hole 13 defined in a side thereof and an electric cord with a plug extends from the same side of the base 11. A storage tank 15 is removably connected to the base 11 and an outlet 17 is defined through a wall of the base 11 and communicates with an interior of the storage tank 15. A one-way valve 18 is engaged with the outlet 17 so as to prevent water from re-entering into the storage tank 15. A cover 19 is pivotably mounted on an open top of the storage tank 15 and a pressure balancing member 191 is connected to a top of the cover 19 so as to balance the inside pressure and the outside pressure of the storage tank 15. A handle 151 is connected to the storage tank 15 so that when the storage tank 15 is disengaged from the base 11, the user can easily carry the storage tank 15 by using the handle 151.

A pump 30 is received in the base 11 and connected to the storage tank 15 via the one-way valve 18 by a first pipe 31 so as to pump water in the storage tank 15 out from the outlet 17. A second pipe 32 is connected between the second hole 13 and the pump 30 and a third pipe 14 is connected between the second hole 13 and a faucet 70 which has a switch 60 which is electrically connected with a control device 20 on the base 11 by a cable 61. The pump 30 is controlled by the control device 20.

A level detection device 40 has a high level detection unit 41 and a low level detection unit 42, wherein the high level detection unit 41 connected between a second pipe 16 and the storage tank 15, and includes a valve located on an inside of the storage tank 15 and a link which is pivotably connected to the valve and extends into the storage tank 15. The low level detection unit 42 is connected to the first pipe 31.

A purifying device 50 is received in the base 11 and a fourth pipe 51 is connected between the first hole 12 and the purifying device 50. The purifying device 50 is a reverse osmosis system which provides pure water to the storage tank 15.

The operation steps of the water purifying system of the present invention includes a step of water feeding, a step of treated by reverse osmosis system 50, a step of storage in the storage tank 15 or being pumped by the pump 30, and s step of water outgoing from the faucet 70.

The purified water is produced by the purifying device 50 and stored in the storage tank 15. When the user operates the switch 60, the control device 20 receives a signal from the switch 60 and activates the pump 30 so that the purified water is pumped from the storage tank 15 to the faucet 70. When the high level detection unit 41 detects that the level is at low position, a signal is sent to the control device 20 to activate the pump 30 to pump water into the storage tank 15 till the level in the storage tank 15 reaches to a desired position, the pump 30 is then stopped. When the low level detection unit 42 detects that no water is left in the storage tank 15, the pump 30 is also be stopped, thereby protecting the pump from being burned.

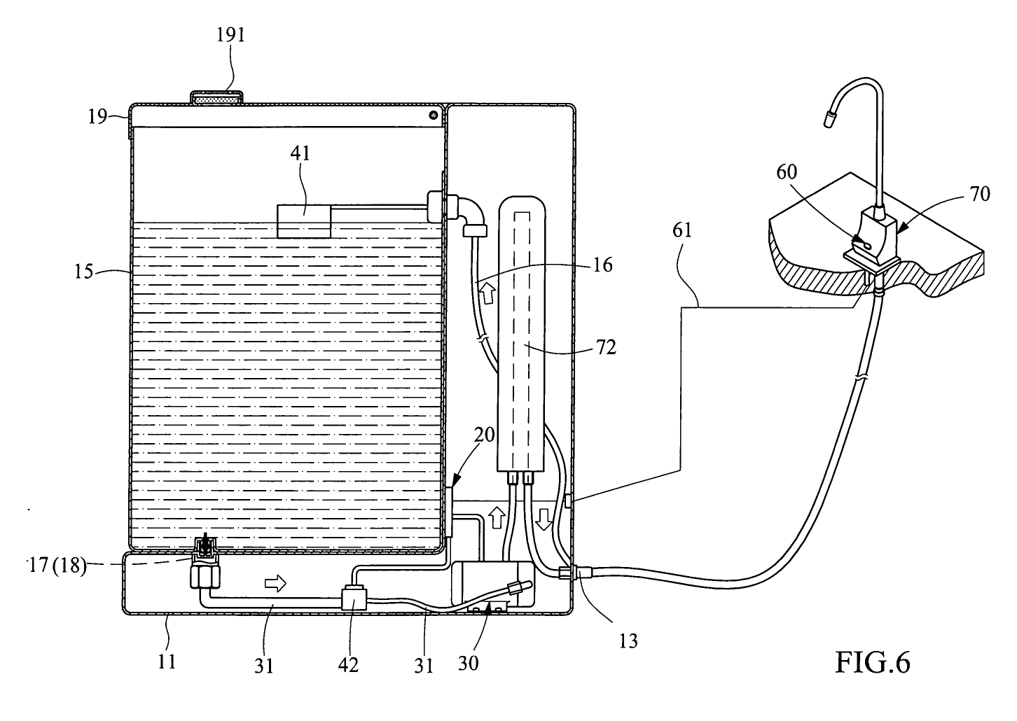

FIG. 6 shows that a ultra-violet sterilizer unit 72 is connected between the pump 30 and the second hole 13 so that the purified water is exposed by the ultra-violet rays before it runs out from the faucet 70 and the ultra-violet sterilizer unit 72 ensures that the water is edible.

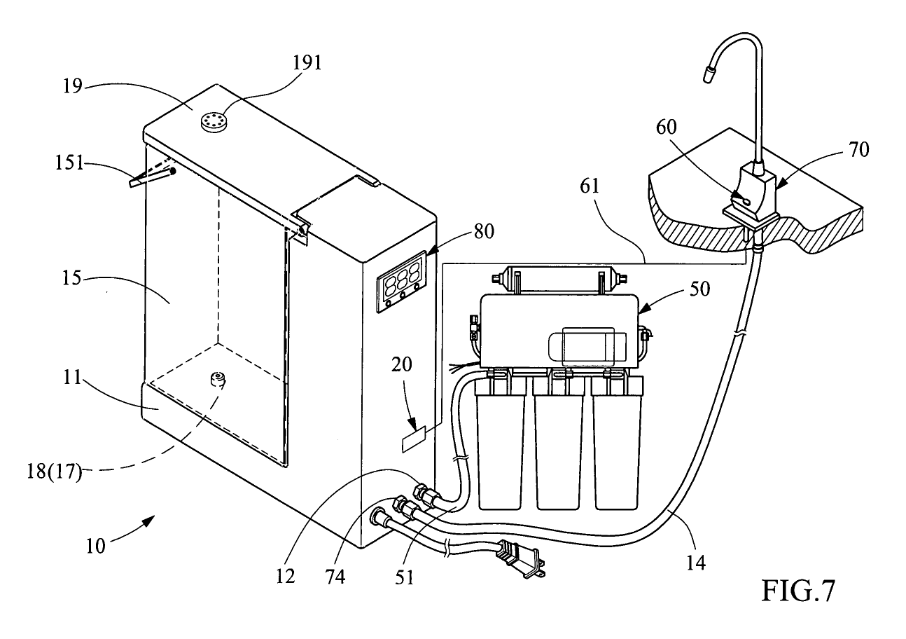

FIG. 7 shows that a one-way device 74 is connected to the third pipe 14 and located between the second hole 13 and the faucet 17 so that the purified water in the third pipe 14 is not allowed to enter into the storage tank 15. A water quality detection device 80 is connected to the base 11 and the purified water in the storage tank 15 or in the second pipe 32 is examined by the water quality detection device 80 and the result is disclosed on the water quality detection device 80.

While we have shown and described the embodiment in accordance with the present invention, it should be clear to those skilled in the art that further embodiments may be made without departing from the scope of the present invention.

What is claimed is:

1. A water purifying system comprising:
a base having a first hole and a second hole, a storage tank removably connected to the base, an outlet defined through a wall of the base and communicating with an interior of the storage tank, a one-way valve engaged with the outlet;
a control device connected to the base;
a pump adapted to pump water in the storage tank out from the outlet, a first pipe connected between the one-way valve and the pump, a second pipe connected between the second hole and the pump, the pump being controlled by the control device;
a level detection device having a high level detection unit and a low level detection unit, the high level detection unit connected between a second pipe and the storage tank, the low level detection unit connected to the first pipe;
a purifying device received in the base and a third pipe connected between the first hole and the purifying device, and
a faucet having a switch which is electrically connected with the control device, a third pipe connected between the faucet and the second hole.

2. The system as claimed in claim 1, wherein a cover is pivotably mounted on an open top of the storage tank.

3. The system as claimed in claim 1, wherein the high level detection unit includes a valve located on an inside of the storage tank and a link which is pivotably connected to the valve and extends into the storage tank.

4. The system as claimed in claim 2, wherein the cover of the storage tank has a pressure balancing member connected thereto.

5. The system as claimed in claim 1, wherein a ultra-violet sterilizer unit connected between the pump and the second hole.

6. The system as claimed in claim 1, wherein the purifying device is a reverse osmosis system.

7. The system as claimed in claim 1, wherein a one-way device is connected to the third pipe and located between the second hole and the faucet.

8. The system as claimed in claim 1, wherein a water quality detection device is connected to the base.

9. The system as claimed in claim 1, wherein a handle is connected to the storage tank.
